(19) United States
(12) Patent Application Publication
(10) Pub. No.: US 2003/0156083 A1
(43) Pub. Date: Aug. 21, 2003

(54) Sparse refresh double-buffering

(76) Inventor: Thomas E. Willis, Mountain View, CA (US)

Correspondence Address: TROP PRUNER & HU, PC, 8554 KATY FREEWAY, SUITE 100, HOUSTON, TX, 77024, US

(21) Appl. No.: 10/079,621

(22) Filed: Feb. 19, 2002

(51) Int. Cl. G09G 3/34

(52) U.S. Cl. 345/84

(57) ABSTRACT

A spatial light modulator having a double-buffering pixel value storage mechanism. A double-buffering mechanism enabling sparse refresh. A double-buffering value storage mechanism suitable for use with a serial or raster value producer and a value consumer, especially those in which it is desirable to consume an entire, completed frame or set of values at a time, and particularly those in which it is desirable to enable the producer to continue producing serially while the consumer is consuming in parallel fashion.

### BACKGROUND

Double-buffering systems are used to provide atomic or at-once update of a set of output data. They are employed in applications in which it is undesirable to present a partially-updated set of output data. One such application is displays such as for personal computers, in which presentation of a partially-updated frame causes the visually undesirable result of “tearing” in which, for a brief time, part of a prior frame is displayed simultaneously with part of a next frame.

FIG. 1 shows an ordinary graphics system 10 which uses double-buffering to avoid such undesirable effects. A raster graphics engine provides pixel data to a first buffer (“buffer A”) or “back buffer”. Upon completion of a frame, control logic transfers the completed frame to a second buffer (“buffer B”) or “front buffer”, which drives a raster display device, such as a cathode ray tube (CRT) display. While that is happening, the graphics engine starts building the next frame in the first buffer. In alternative systems, the two buffers operate in “ping-pong” fashion rather than “back-front” fashion.

FIG. 2 shows a spatial light modulator (SLM) 20, which is a special case of display. SLMs are used to inject graphical or video content into a light beam. They can be reflective or transmissive. An SLM can be simplistically envisioned as an X by Y grid or array of pixel elements or cells 22, each of which controls the amount of light reflected or transmitted through its geographic region of the SLM. The array is controlled by control logic 24, and its output may be directed to a display 26 or used otherwise. Each pixel element typically consists of an analog device such as a liquid crystal cell which responds to a voltage or current applied to its electrode. Commonly, there may be plural subsets of pixel elements each dedicated to a distinct color space, such as red, green, and blue pixel elements in an RGB display. Each pixel element is typically driven according to a multi-bit pixel color value stored in a storage location uniquely associated with that pixel element.

In conventional display and SLM systems, the entire image is regenerated each new frame. This might be termed “complete refresh”. In the future, displays may use “sparse refresh”, in which only changed portions of the image are generated for a new frame.

Traditional back-front or ping-pong double-buffering does not work in sparse refresh systems, because in the known double-buffering systems, one of the buffers (the back buffer, or the ping-pong buffer not presently driving the display) are completely regenerated (meaning all of its locations will be rewritten) before being committed to the display. If used with a conventional double-buffering system, sparse refresh would leave neither buffer holding a complete and current image. What is needed, then, is a double-buffering system which allows sparse refresh without tearing and so forth.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 illustrates a double-buffered raster display system according to the prior art.

FIG. 2 illustrates a spatial light modulator according to the prior art.

FIG. 3 illustrates one embodiment of the double-buffered circuitry of this invention.

FIG. 4 illustrates another embodiment of the double-buffered circuitry.

FIG. 5 illustrates one embodiment of a spatial light modulator including the double-buffered circuitry of this invention.

FIG. 6 illustrates one embodiment of a method of operation of the double-buffering system of this invention.

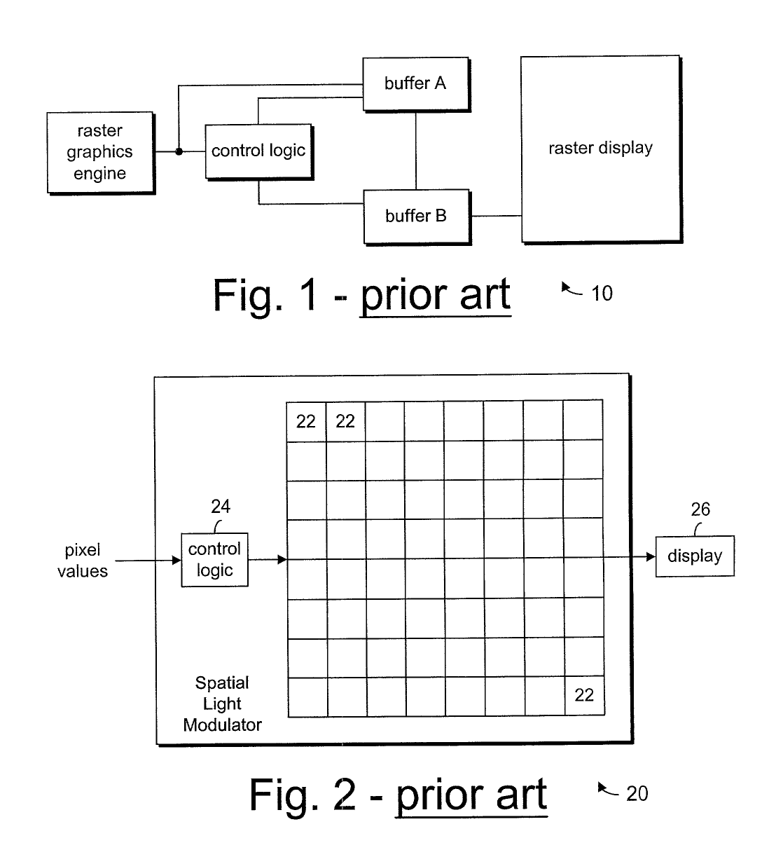

### DETAILED DESCRIPTION

While the invention will be described in terms of its application to display technology, and specifically to SLM display technology, the reader will appreciate that the invention can readily be utilized in other areas of technology, as well, and that the claims are not to be read as though limited to SLMs or displays. Similarly, while the invention is described with reference to updating frames of pixel values, the double-buffering invention can readily be used with other types and sizes of data in other applications. For example, it may be used in storage, memory, caching, or other situations. Thus, it can more generically be said that the invention enables sparse refresh double-buffering of multiple values from a source to a destination. The destination may be an SLM, a memory, or whatever.

One motivation for using the invention might be that, due to the nature of the application, it is undesirable to present incompletely updated frames or sets of data. Another might be the desire to employ sparse refresh or update of the data, to reduce the bandwidth required or the power consumed. The reader will, doubtless, find other motivations and usages after studying this disclosure.

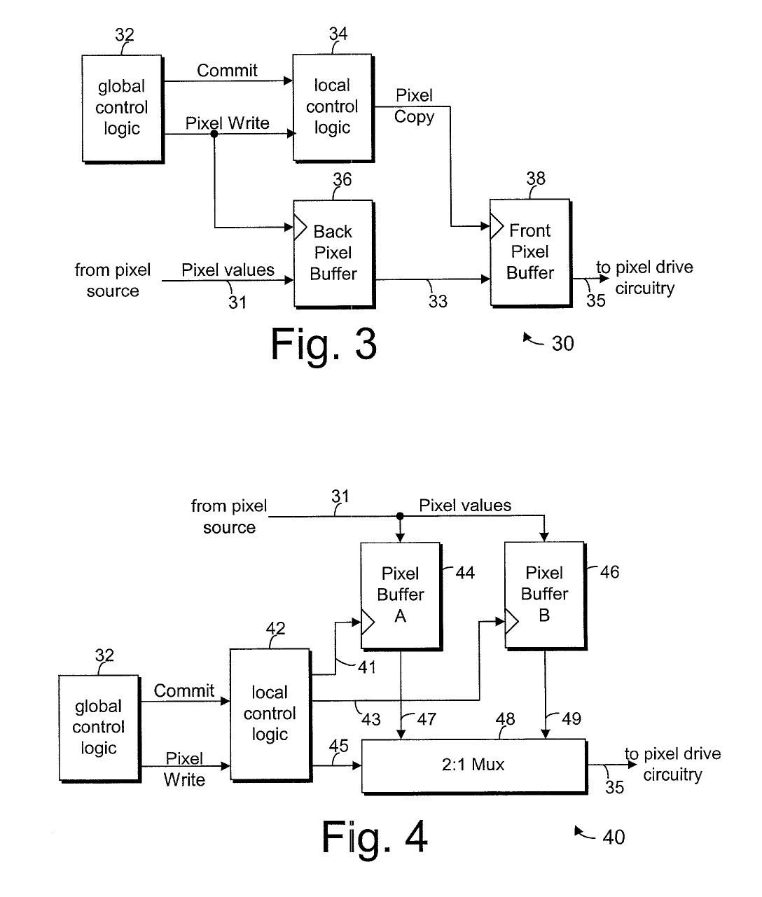

FIG. 3 shows a back-front embodiment of a double-buffering circuit 30. Global control logic 32 controls the operation of all pixels. Each pixel has local logic including local control logic 34, a back pixel buffer 36 with a value input and a control input, and a front pixel buffer 38 with a value input and a control input. The back pixel buffer holds the new pixel value while the frame buffer is being updated. The front pixel buffer holds the present value that is being driven to the SLM pixel and displayed to the user.

The back pixel buffer has a value input at which it receives a pixel value, typically a multi-bit pixel value such as an 8-bit Green value, as one example. The pixel value is received over a serial or parallel link 31 from the pixel source, such as a graphics engine. The global control logic determines when this particular pixel cell's pixel value is being written by the pixel source (which writes serially to the various pixels), and issues a pixel write signal to this pixel cell's double-buffering circuitry, causing the back pixel buffer to read or latch the pixel value. The local control logic receives the pixel write signal, as well as a commit signal from the global control logic. The commit signal indicates when the value in the back pixel buffer should be committed or written to the front pixel buffer; meaning typically that this frame's updates are now completed.

Upon receiving the pixel write signal, the local control logic sets a “dirty bit” (not shown) indicating that the pixel has been written to. If the dirty bit is set when the commit signal is received, the local control logic issues the pixel copy signal, causing the front pixel buffer to read or latch the new pixel value from the back pixel buffer, and clears the dirty bit.

The commit signal may be implicit, or it may be explicit, depending upon the needs of the particular application. That is, it may be implicitly generated by the global control logic after all the pixels in some set are written to the array, or it may be explicitly generated by the pixel source itself. For example, a system with selective refresh might present packets with rectangular regions of pixels that are to be updated to the SLM. The semantics of the regions may be such that the commit signal is asserted after the pixels in the region are written into the pixel array. Or, the pixel source may use a predetermined packet type to indicate that the commit signal should be issued.

FIG. 4 shows a ping-pong embodiment of double-buffering circuitry 40 which may be used in an SLM or the like. The pixel value is received by a first pixel buffer 44 (“pixel buffer A”) and a second pixel buffer 46 (“pixel buffer B”) in parallel. The local control logic 42 provides either a first read enable signal 41 to the first pixel buffer, or a second read enable signal 43 to the second pixel buffer, so only one of them will latch the new value. In some embodiments, the local control logic may issue a single read enable signal to both buffers, with one of them having an inverted input.

The local control logic provides a mux select signal 45 to a multiplexor 48 which, accordingly, passes through the output of either the first or the second pixel buffer to the pixel drive circuitry (not shown). While the new frame is being constructed, the mux will be controlled to pass the output of the pixel buffer which was not enabled to latch the new value, or, in other words, the old pixel value. In response to the commit signal from the global control logic, the local control logic will clear its dirty bit as described above, and will then toggle the mux control signal, causing the new value to be provided to the pixel drive circuitry. The pixel write signal operates as described above.

FIGS. 3 and 4 have been described with reference to one example scenario in which there is one double-buffering circuit dedicated to each pixel, and in which that double-buffering circuit has a dedicated local control logic, and dedicated back and front buffer storage elements, and there is a dedicated dirty bit for each pixel. However, the reader should appreciate that, depending upon the needs of the application, the system may be differently partitioned. The pixel write signal may more generically be regarded as a region write signal, and the system may contain more than one of them. The display may be divided into distinct regions, such as rectangles, each having its own region write signal, and each thus being atomically updated to the display independently of the other regions. The regions may be regular, or they may be irregular. They may have different sizes and/or shapes. They may be hard-wired and static, or they may be dynamically determined such as under program control. They may be non-overlapping, or they may be overlapping; for example, in an RGB display, the red pixels could be one region, the green a second, and the blue a third. The pixels in a region can share a single dirty bit.

Furthermore, it is not necessarily the case that each pixel have its own, dedicated local control logic. Each region may have its own, single local control logic, with appropriate fanout of its pixel copy signal to all of the pixels in that region.

And it may, in some applications, be desirable to implement the various pixels' or regions' pixel buffers in a variety of partitionings. As one example, each pixel may have its own, distinct buffers, and in some cases they may be built directly within the confines of that pixel's display area. As another, each X-pixel-wide row of the display may have its own X-wide buffer, and in some cases these may be built at the edge of the display area adjacent their respective rows. As another, all of the buffer storage may be built together in a unified block.

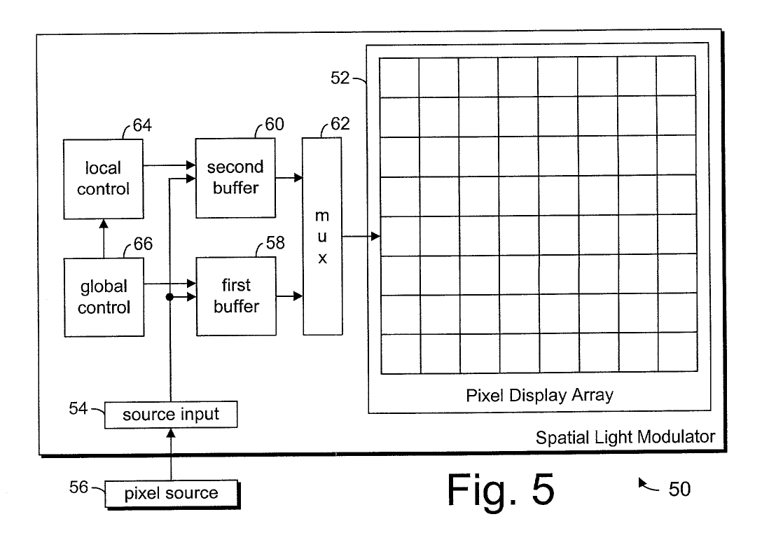

FIG. 5 shows one embodiment of an SLM 50 built to incorporate either embodiment of the double-buffering circuitry (which is shown somewhat generically and is intended to suggest either of the two embodiments, or other suitable mechanisms, and should be understood to also represent region-based embodiments not just pixel-based embodiments). Pixel values arrive at a source input 54 from a pixel source 56 which may be external to the SLM in many embodiments. From there, the pixel values are provided to the first and second pixel buffers 58, 60 of the various pixel array cells. For simplicity in illustration, only a single pixel array cell's double-buffering circuitry is shown. The global control logic 66 controls the local control logic 64. The control logic controls the buffers and the multiplexor 62, as described above. The output value is provided to pixel drive circuitry (not shown) which may typically include a digital-to-analog converter, a pulse width modulation circuit, or other suitable means for driving the pixel's electrode.

The pixel drive circuitry is typically, but not necessarily, located within the pixel cell's geographic region.

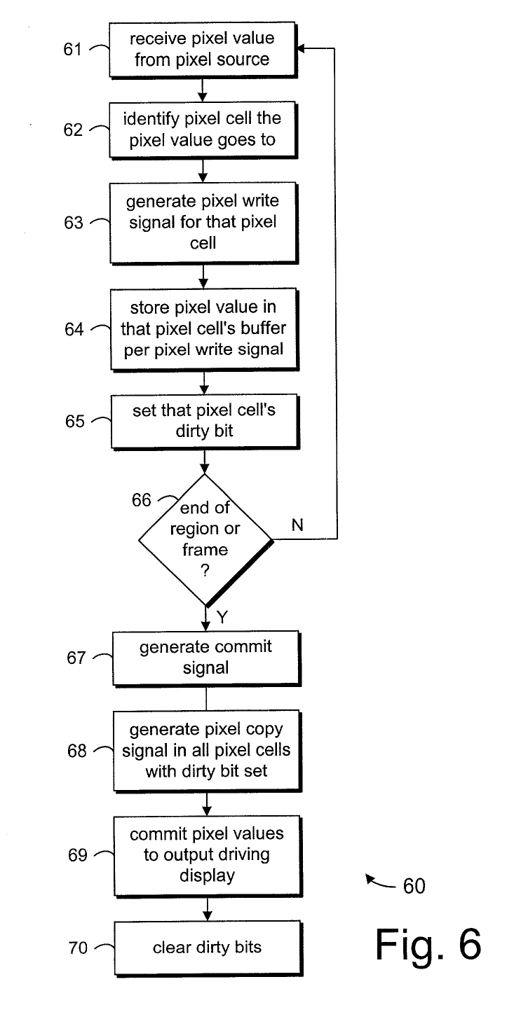

FIG. 6 shows one embodiment 60 of a method of operation of the double-buffering circuitry. A pixel value is received (61) from the pixel source. The pixel cell into which this pixel value is being written is identified (62), and a pixel write signal is generated (63) for that cell. In response to the pixel write signal, the pixel value is stored (64) in that pixel cell's buffer, and that pixel cell's dirty bit is set (65). If (66) the pixel source has not finished writing to this region, (or to this frame, for example) operation continues by receiving (61) a next pixel value for it, and so forth. Otherwise (66), a commit signal is generated (67). In response to the commit signal, a pixel copy signal is generated (68) in all pixel cells that have been written to (or, in other words, those that have their dirty bits set). In response to the pixel copy signal, each such pixel cell commits (69) its respective newly-stored pixel value to an output of the pixel cell which is, for example, driving a display pixel, and clears (70) its dirty bit. In a back-front double-buffering system, the committing (69) includes copying the pixel value from the back buffer to the front buffer. In a ping-pong double-buffering system, the committing (69) includes inverting the multiplexor control signal.

While the invention has been described in terms of an SLM, the reader will appreciate that the double-buffering invention taught by this disclosure may find usefulness in other applications, as well, especially those in which a serial or raster value producer is coupled to a parallel value consumer. The graphics engine is one example of a serial or raster value producer. The SLM is one example of a parallel value consumer.

And while the invention has been described with reference to buffering values which are pixel values, the reader will appreciate that the invention may be utilized in other applications involving other types of data, as well. In such applications, the pixel write signal may simply be termed a “write signal”, which term may also generically apply to its embodiment as a pixel write signal. Similarly, the pixel copy signal may be simply termed a “copy signal”.

There are many suitable ways of describing the various values. The value from the pixel source may be termed a “new value” or a “next value” or the like, and the value being provided to the pixel drive circuitry may be termed a “current value” or an “old value” or a “previous value” or the like.

The reader should appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media. The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An apparatus comprising:
global control logic for providing a commit signal and a write signal; and
a double-buffering circuit including,
local control logic coupled to receive the commit signal and the write signal, for providing a copy signal in response to the commit signal if the write signal was received subsequent to receipt of a previous commit signal,
a first buffer having a value input for receiving a new value from a source and having a control input for receiving the write signal, and for storing the new value in response to the write signal, and
a second buffer having a value input for receiving the new value from the first buffer and having a control input for receiving the copy signal, and for storing the new value as an old value in response to the copy signal.

2. The apparatus of claim 1 wherein:
the new value and the old value each comprises a multi-bit pixel value.

3. The apparatus of claim 1 further comprising:
a plurality of such double-buffering circuits.

4. The apparatus of claim 3 further comprising:
a spatial light modulator having a plurality of pixel display cells each coupled to the second buffer of a respective one of the double-buffering circuits.

5. The apparatus of claim 1 wherein the double-buffering circuitry further includes:
another first buffer having a value input for receiving another new value from the source and having a control input for receiving the write signal, and for storing the other new value in response to the write signal, and
another second buffer having a value input for receiving the other new value from the other first buffer and having a control input for receiving the copy signal, and for storing the other new value as another old value in response to the copy signal.

6. The apparatus of claim 1 wherein:
the first and second buffers are each for storing a single multi-bit pixel value.

7. The apparatus of claim 1 wherein:
the commit signal is implicit.

8. An apparatus comprising:
global control logic for providing a commit signal and a write signal;
a double-buffering circuit including,
a first buffer and a second buffer coupled to receive a value from a source,
a multiplexor coupled to receive values stored by the first and second buffers,
local control logic coupled to receive the commit signal and the write signal, for providing a mux select signal to the multiplexor to cause the multiplexor to pass either the value stored by the first buffer or the value stored by the second buffer, and for issuing, in response to the write signal,
a first read enable signal to the first buffer if the multiplexor is 12 passing the value stored by the second buffer, or
a second read enable signal to the second buffer if the multiplexor is passing the value stored by the first buffer,
and, in response to the commit signal, for toggling the mux select signal if the write signal was received subsequent to a most recent prior receipt of the commit signal.

9. The apparatus of claim 8 wherein the value from the source comprises a multi-bit pixel value and the first and second buffers comprise multi-bit buffers.

10. The apparatus of claim 8 further comprising:
a plurality of such double-buffering circuits.

11. The apparatus of claim 10 further comprising:
a spatial light modulator having a plurality of pixel display cells each coupled to receive the value passed by the multiplexor of a respective one of the double-buffering circuits.

12. The apparatus of claim 8 wherein the double-buffering circuitry further includes:
another first buffer having a value input for receiving another new value from the source and having a control input for receiving the write signal, and for storing the other new value in response to the write signal, and
another second buffer having a value input for receiving the other new value from the other first buffer and having a control input for receiving the copy signal, and for storing the other new value as another old value in response to the copy signal.

13. The apparatus of claim 8 wherein:
the first and second buffers are each for storing a single multi-bit pixel value.

14. An apparatus for use with a series of values received from a serial value producer, the apparatus comprising:
a value consumer; and
a double-buffering mechanism coupled between the serial value producer and the value consumer, the double-buffering mechanism including,
global control logic for issuing a commit signal and a write signal, and
a plurality of local logic mechanisms for providing values in parallel to the value consumer, each local logic mechanism including,
a first buffer,
a second buffer,
wherein one of the first and second buffers will store a previously received value from the serial value producer and provide the stored value to the value consumer, and
local control logic responsive the write signal to cause the other of the first and second buffers to store a new value from the serial value producer, and responsive to the commit signal to cause the other rather than the one of the buffers to provide its stored value to the value consumer if the write signal was received subsequent to a most recent previously received commit signal.

15. The apparatus of claim 14 wherein the value consumer comprises a spatial light modulator.

16. A method of passing new pixel values from a source to a spatial light modulator which has multiple pixel display cells, the method comprising:
(A) for each respective new pixel value from the source,
buffering the new pixel value in a first buffer coupled to the pixel display cell to which that new pixel value is to be written,
continuing to drive the pixel display cell with a previously received pixel value, and
setting a dirty bit indicating that the display pixel cell has been written to; and
(B) at the end of a frame of new pixel values, for each pixel display cell to which a new value was written,
committing the buffered new value to an output coupled to drive the pixel display cell, and
clearing the dirty bit to indicate that the pixel display cell has not been written to since being committed.

17. The method of claim 16 wherein committing the buffered new value comprises:
copying the new value from a second buffer not coupled to drive the pixel display cell to the first buffer coupled to drive the pixel display cell.

18. The method of claim 16 wherein committing the buffered new value comprises:
toggling a multiplexor coupled to outputs of two buffers, one of which is the first buffer; and
toggling operation of local control logic such that upon receipt of a next value written by the source to the same pixel display cell, the other of the two buffers will buffer the next value.

19. A method of operating a spatial light modulator, the method comprising:
driving respective pixel values of an old frame to corresponding pixel display cells of a display cell array;
(A) receiving a new frame of new pixel values;
(B) for each new pixel value in the new frame, buffering the new pixel value while continuing to drive a corresponding pixel value of the old frame to the display cell array; and
(C) upon completion of receipt of the new frame, transferring the new pixel values in parallel to corresponding pixel display cells of the display cell array.

20. The method of claim 19 wherein the transferring comprises:
latching from a first buffer to a second buffer.

21. The method of claim 19 wherein the transferring comprises:
toggling operation of a multiplexor to pass to its output a value from a first buffer rather than a second buffer.

22. A spatial light modulator comprising:
a display having a plurality of regions, each region including at least one display pixel;
global control means for providing to each of the regions a respective write signal, and for providing a commit signal; and
for each of the regions,
buffer means for buffering values and including a first buffer and a second buffer, and
local control means, coupled to receive the region's write signal and the commit signal, for providing a control signal to the buffer means in response to receiving the commit signal if the write signal has been received subsequent to an immediately prior receipt of the commit signal
wherein the control signal causes one of the first and second buffers to present its buffered value to the display.

23. The spatial light modulator of claim 22 wherein:
the first and second buffers are configured as a back-front buffer and the control signal comprises a copy signal.

24. The spatial light modulator of claim 22 wherein:
the first and second buffers are configured as a ping-pong buffer with a multiplexor and the control signal comprises,
a multiplexor control signal coupled to the multiplexor,
a first read enable signal coupled to the first buffer, and
a second read enable signal coupled to the second buffer.

25. The spatial light modulator of claim 24 wherein:
the local control means is coupled to issue one of the first and second read enable signals, and the other of the first and second read enable signals is generated by an inverted input at one of the first and second buffers.

26. The spatial light modulator of claim 22 wherein:
each region contains exactly one display pixel, and each display pixel has its own dedicated local control means.

27. A method of performing sparse refresh of a display, the display including a plurality of regions each containing at least one display pixel, the method comprising:
driving the at least one display pixel of each region according to a present value stored in a driving buffer of a double-buffering mechanism uniquely associated with that region;
updating a non-driving buffer of the double-buffering mechanism of less than all of the regions; and
driving the at least one display pixel of each region according to the present value if the region was not updated, and according to the updated non-driving buffer if the region was updated.

28. The method of claim 27 wherein updating comprises:
writing a new value to the non-driving buffer; and
copying the new value from the non-driving buffer to the driving buffer.

29. The method of claim 27 wherein updating comprises:
writing a new value to the non-driving buffer;
making the non-driving buffer be driving; and
making the driving buffer be non-driving.

30. The method of claim 29 wherein the makings are accomplished by:
toggling operation of a multiplexor coupled to outputs of the buffers.

31. The method of claim 27 wherein:
at least one of the regions includes a plurality of pixels.

32. The method of claim 27 wherein the display comprises a spatial light modulator.

33. A method of performing sparse refresh in a system having a set of first buffers and a set of second buffers and a multi-location destination, the method comprising:
first driving the destination with previous values while,
updating a subset of the buffers with new values;
leaving a remainder of the buffers un-updated; and
second driving the destination with the new values from the updated buffers and the previous values from the non-updated buffers only after completion of the updating.

34. The method of claim 33 wherein:
the first buffers comprise back buffers;
the second buffers comprise front buffers;
the first driving comprises driving from the front buffers;
the updating comprises,
updating a subset of the back buffers, and
transferring the updated subset of the back buffers to a corresponding subset of the front buffers only after completion of updating the subset of the back buffers; and
the second driving comprises driving the destination from the front buffers.

35. The method of claim 33 wherein:
the first and second sets of buffers comprise sets of corresponding pairs of ping-pong buffers; and
the updating comprises,
toggling operation of multiplexors coupled to the updated subset of the values;
wherein the updated buffers include buffers from the first set and buffers from the second set.

36. The method of claim 33 further comprising:
sharing a dirty bit for plural locations in the destination, to enable refresh of those plural locations as an atomic region.

37. An article of manufacture bearing data which, when accessed by a machine, cause the machine to construct the apparatus of claim 1.

38. The article of manufacture of claim 37 bearing further data which, when accessed by the machine, cause the machine to construct the apparatus of claim 4.

39. The article of manufacture of claim 37 further comprising:
a carrier wave upon which the data are carried.

40. The article of manufacture of claim 37 further comprising:
a recording medium upon which the data are recorded.

41. An article of manufacture bearing data which, when accessed by a machine, cause the machine to construct the apparatus of claim 8.

42. The article of manufacture of claim 41 bearing further data which, when accessed by the machine, cause the machine to construct the apparatus of claim 10.

43. The article of manufacture of claim 41 further comprising:
a carrier wave upon which the data are carried.

44. The article of manufacture of claim 41 further comprising:
a recording medium upon which the data are recorded.

45. An article of manufacture bearing data which, when accessed by a machine, cause the machine to perform the method of claim 16.

46. The article of manufacture of claim 45 bearing further data which, when accessed by the machine, cause the machine to perform the method of claim 17.

47. The article of manufacture of claim 45 bearing further data which, when accessed by the machine, cause the machine to perform the method of claim 18.

48. The article of manufacture of claim 45 further comprising:
a carrier wave upon which the data are carried.

49. The article of manufacture of claim 45 further comprising:
a recording medium upon which the data are recorded.
